(19) United States
(12) Patent Application Publication
(10) Pub. No.: US 2003/0029283 A1
(43) Pub. Date: Feb. 13, 2003

(54) Multiple screwdriver

(76) Inventor: Ran Yaar, Vancouver (CA)

Correspondence Address: Frederick Kaufman, Suite 403, 1937 Pendrell Street, Vancouver, BC, V6G 1T4, CA

(21) Appl. No.: 10/050,099

(22) Filed: Jan. 18, 2002

(30) Foreign Application Priority Data
Aug. 13, 2001 (CA) 2,354,999

(51) Int. Cl. B25B 23/00

(52) U.S. Cl. 81/438

(57) ABSTRACT

A multiple screwdriver includes a tubular body having, at one end, a tip and, at the other end, a cap. The tubular body has an axially extending bore, a first cylinder end in a zone of the tip and a second cylindrical end in a zone of the cap. Between the end of the first cylindrical end and a rim with a hexagonal opening provided at an exit of the tip, a C-shape springy element is located. The internal circumference of the latter circumscribes the hexagonal opening, so that a shank of an interchangeable screwdriver tip can be prevented from falling out. After several interchangeable screwdriver tips are inserted successively through the top of the cap into the axially extending bore and the first interchangeable screwdriver tip has its bit projecting out of the tip, the last interchangeable screwdriver tip is so situated that its top is beneath a hexagonal configuration provided at the top of the switch. By pivoting the switch to the right or left, the hexagonal configuration can coincide or not with a hexagonal cross section of the axially extending bore. If it coincides, the tips can be inserted or let fall out. When it does not coincide, the interchangeable screwdriver tips are confined in the tubular body.

### I. BACKGROUND OF THE INVENTION

1. Technical Field

The invention generally relates to pocket screwdrivers, and more particularly, to a multiple screwdriver having several interchangeable tips, removably retained in a tubular body of the screwdriver.

2. Description of the Related Prior Art

Attempts have been made to develop a reliable multiple screwdriver with an extended service life, easy to use and having a reduced cost of manufacture.

For example, U.S. Pat. No. 4,827,812. Granted on May 9, 1989, to Markovetz for a “Pocket screwdriver” describes a screwdriver using a hollow shaft with first and second ends. The first end has an interior cavity adapted to engage a shank of a screwdriver tip. A magnet is attached to the interior of the hollow shaft for holding the screwdriver tip inserted in the first end. The magnet divides the hollow shaft in a storage compartment and tool-receiving compartment. A torque cap is used. It consists of three segments: a first segment is sized for insertion into the torque cap-receiving hole; a second segment extends from the first segment and is sized for insertion into the storage compartment; and a third segment extends also from the first segment, oppositely to the second segment. The first and second segments are fitted with detent balls. The above pocket screwdriver presents several shortcomings. First, it has a limited capacity for storage, due to the space taken by first and second segments. Secondly, the magnet prevents the use of this screwdriver near computers or other magnet sensitive devices.

U.S. Pat. No. 5,450,775 granted on Sep. 19, 1995 to Kozak for a “Multiple function driving tool” describes a tool having first and second ends with the first end having an opening for receiving a screwdriver tip, while the second end has an opening for receiving a tube which is releasably retained, in relation to the handle, by a collet. The handle has opposed side openings extending from the second end to a point near the collet. The tube is mounted for a limited axial sliding movement relative to the handle, from a position where one of its ends is retained by the collet, to a position where it is no longer retained by the collet. Thus, one can position the tube in alignment with the side opening in the handle. The tube is also mounted for pivoting movement when it is in alignment with the side opening, to a generally transversally extending position. The tube is of a length sufficient to always project outwardly of the handle, when the tube is generally in actually aligned relation to the handle. Kozak's structure has several shortcomings. First, the pivoting of the whole tube in the handle and its limited axial sliding movement relative to the handle complicates the tool configuration. Second, due to this complicated structure the components do not easily cooperate.

U.S. Pat. No. 5,842,394, granted on Dec. 1, 1988 to Hwang for a “Multiple bit screwdriver” discloses a tubular handle body with a first end position, and opposite second end position and an axial bore formed through the first and second end positions. A plurality of tool tips are inserted into the axial bore via the first end position, and are removable from the axial bore via the second end position. Each of the tool tips has a bit portion and a connecting sleeve on one end of the bit portion. The connecting sleeve has an axial blind hole formed therein to allow extension of the bit portion of an adjacent tool bit therein. First and second spring units are respectively provided on the first and second end portions, where they extend radially inward into the axial bore. The first spring unit engages frictionally and resiliently the connecting sleeve of a first one of the tool tips, that is located in the first end portion of the handle body, so as to prevent the tool tips from falling out of the first end portion. The second spring unit engages frictionally and resiliently the connecting sleeve of the second one of the tool tips that has the bit portion extending out of the second end portion. The second spring prevents the tool bits from falling out of the second portion. This screwdriver is considered having the following shortcomings. First, use is made of special tips, non-standardized, which are not common in the field of interchangeable screwdriver tips. Second, the spring unit being intended to engage only frictionally and resiliently the connection sleeves of the screwdriver tips, do not efficiently prevent the expelling of the tips from the first end portion when the screwdriver is pushed towards a fastener which must be tightened or untightened.

### II. SUMMARY OF THE INVENTION

There is, accordingly, a need for a multiple screwdriver, which overcomes the disadvantages of the prior art. It is further desirable to have a multiple screwdriver, which is simple to assemble, practical to use and well engineered so that components are reliable.

The present invention is directed to a multiple screwdriver, which comprises, in combination, a tubular body having two ends. A tip is attached to one end and a cap is attached to the other end. The tubular body incorporates a first cylindrical end, generally located to positionally correspond to the tip, and a second cylindrical end, general dispose to positionally correspond to the cap. An axially extending bore of hexagonal cross section is formed in the tubular body and provides a storage compartment adaptable for retaining several interchangeable screwdriver tips. Each of the latter has a shank with a hexagonal cross section commensurable with the axially extending bore. The tip has a cylindrical opening which ends at an outer end with an inwardly extending centering rim having a hexagonal aperture for an easy passage of the interchangeable screwdriver tips. A C-shaped springy element is located in the tip between the inwardly extending centering rim and the first cylindrical end. The C-shaped springy element is so dimensioned that its internal circumference circumscribes the hexagonal aperture in the inwardly centering rim. The C-shaped springy element frictionally engages the last shank whose bit is outwardly projecting from the tip. The cap has, at its top, a disk shaped opening, for an easy passage of the interchangeable screwdriver tips. An open window, which is formed in a lateral wall of the cap, has a wide part at the top, which continues downwardly with a narrow part. The wide part has a lateral side collinear with a lateral side of the narrow part. A switch of tubular form is coaxially aligned and diametrically commensurate with the second cylindrical end. The switch is provided on its external surface by a tooth projection. The interior of the switch is generally cylindrical, except at the top where a hexagonal configuration is formed. The latter corresponds to the cross section of the shanks. The rest of the interior is sized to allow an easy passage of the interchangeable screwdriver tips. By pivoting the tooth projection in one direction or in an opposite direction, the hexagonal configuration in the top of the switch can take a position coinciding dimensionally and positionally with the axially extending bore, or can take an opposite position wherein the hexagonal configuration on the top of the switch and in the hexagonal cross section of the axially extending bore do not coincide.

In a preferred application, tubular body has, in cross section, a generally trapezoidal periphery with rounded corners. Toward the tip, the tubular body extends axially and changes in a truncated cone, followed by the first cylindrical end. One of the external faces of the tubular body has a part of his length flattened. The first cylindrical end, having a reduced cross section in comparison with the smallest cross section of the truncated cone, forms a shoulder. A notch outwardly open is formed in the first cylindrical end, at an external end of the latter. The second cylindrical end has on its periphery two spaced longitudinal ribs.

### III. BRIEF DESCRIPTION OF THE DRAWINGS

Although the characteristics features of the invention will be particularly pointed out in the claims, the invention itself and the manner in which it may be made and used, may be better understood in the following description taken into connection with the accompanying drawings, wherein like reference numerals refer to like parts throughout the several views, in which

FIG. 1 is a perspective exploded view of the multiple screwdriver;

FIG. 2 is a perspective view of the multiple screwdriver showing details of the first end;

FIG. 3 is a perspective view of the tubular body of the multiple screwdriver showing details of the second end;

FIG. 4 is the perspective view of the tip viewed from the front;

FIG. 5 is the perspective view of the tip viewed from the back;

FIG. 6 is the cross section of the tip and partially of the tubular body, together with an interchangeable screwdriver tip;

FIG. 7 is the perspective view of the cap viewed from the front;

FIG. 8 is the perspective of the cap viewed from the back;

FIG. 9 is an enlarged fragmentary view of the cap; and

FIG. 10 is the perspective view of the switch.

### IV. DESCRIPTION OF A PREFERED EMBODIMENT

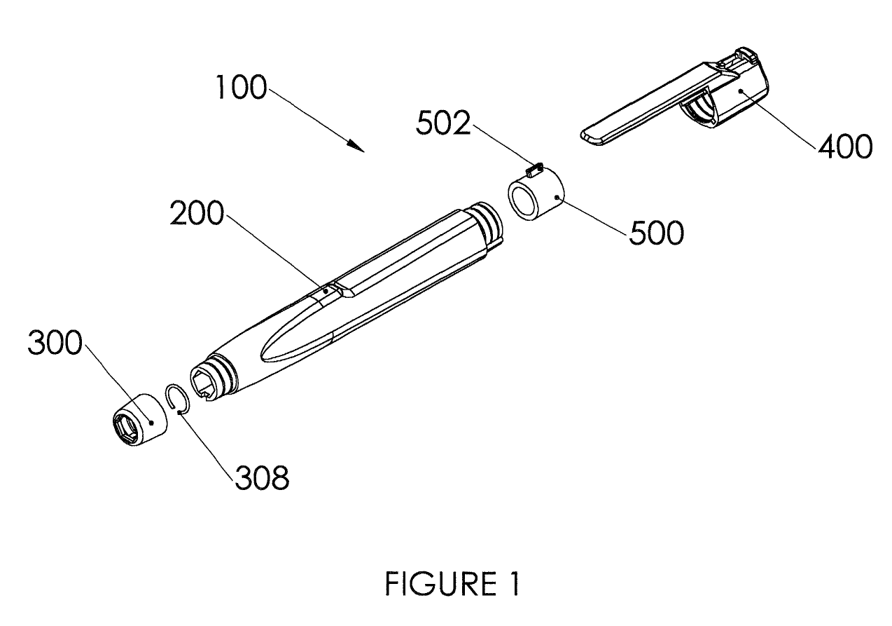

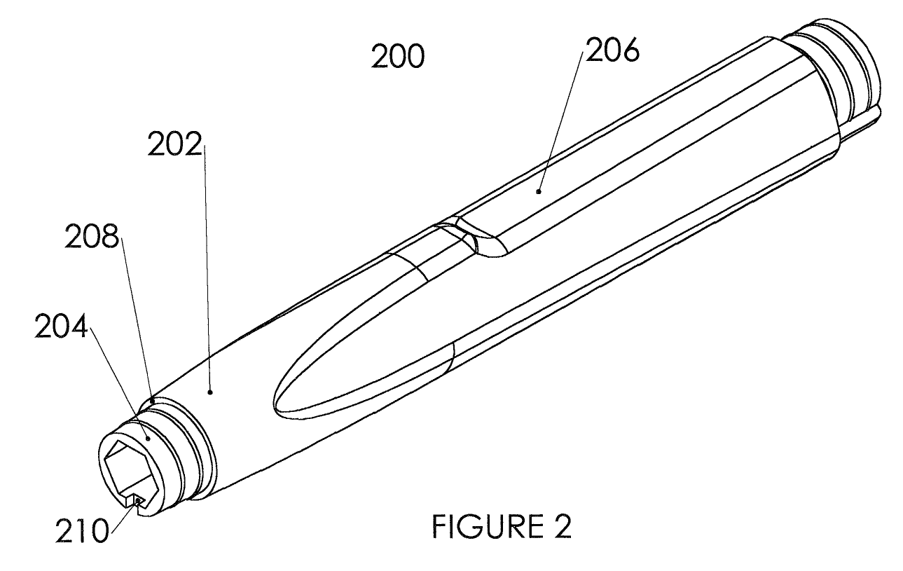

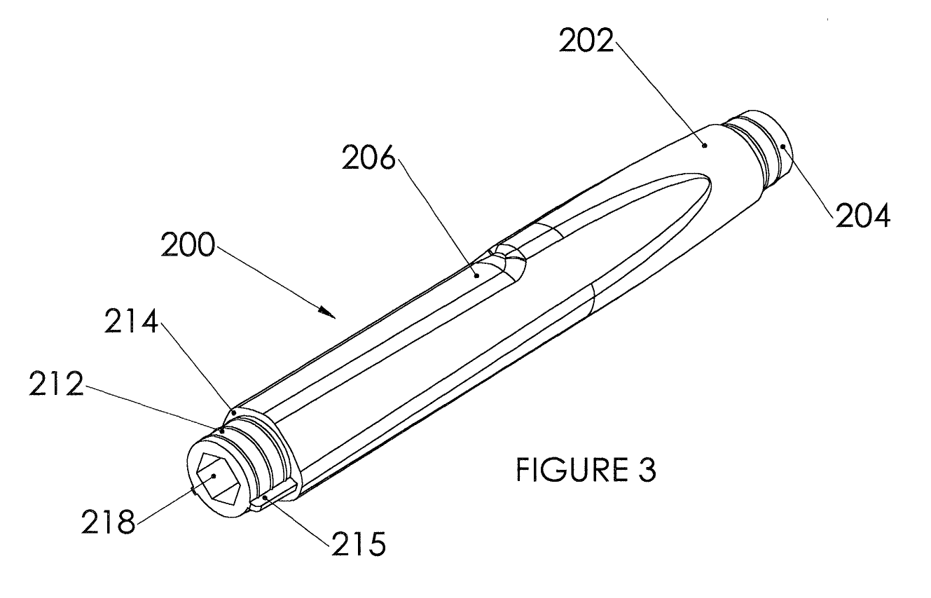

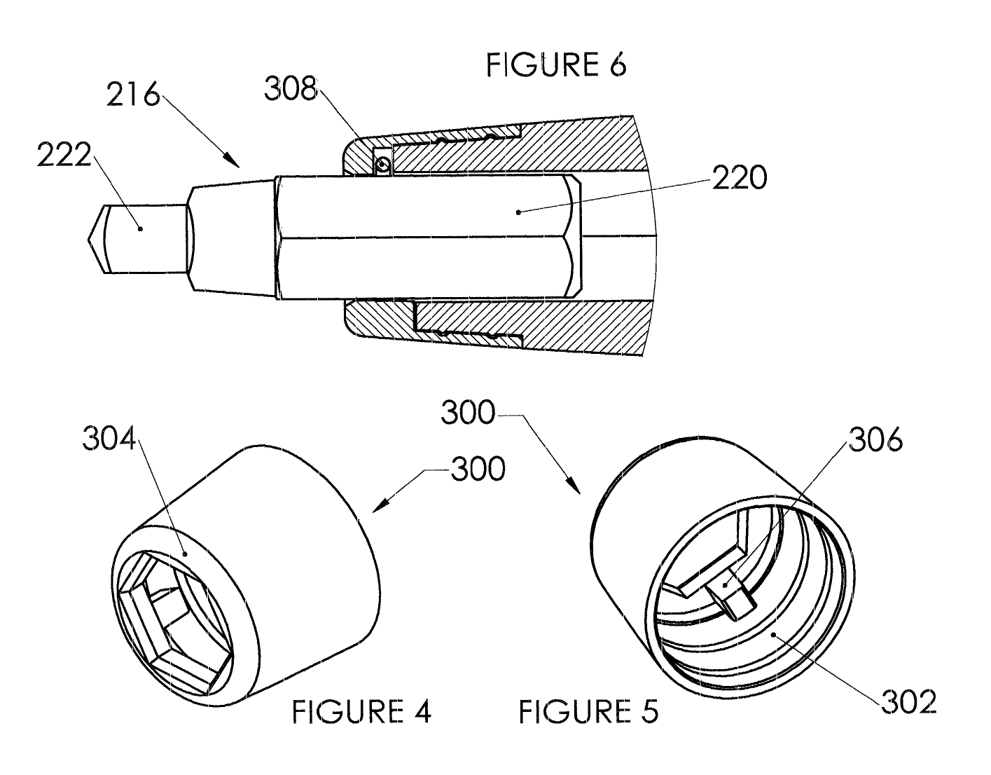

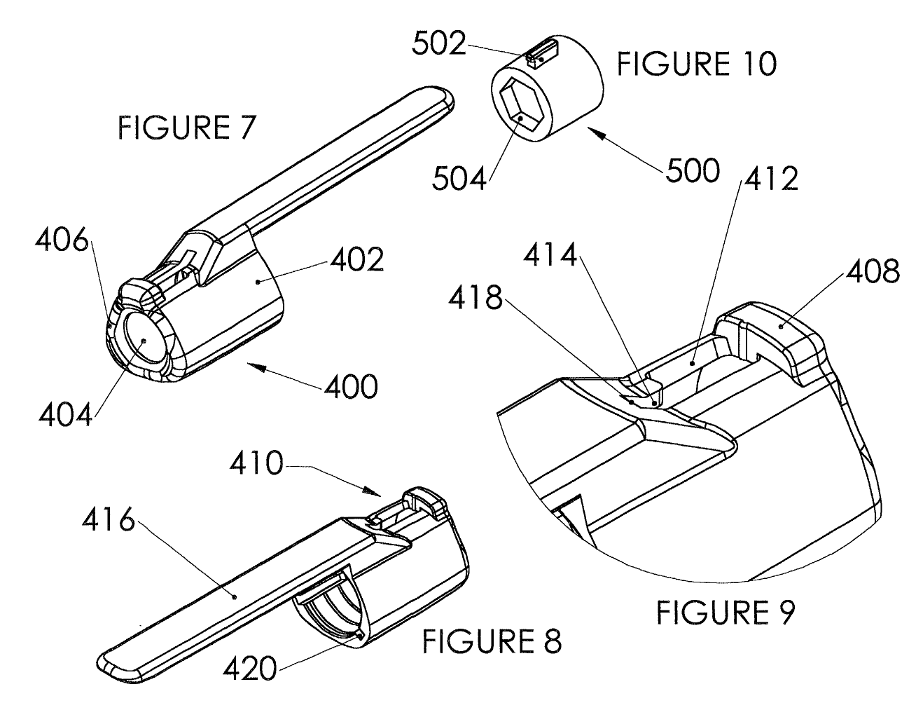

Referring to FIGS. 1 to 10, a multiple screwdriver 100, according to the preferred embodiment, is shown to include a tubular body 200, to which, at one end, a tip 300, and, at the opposite end, a cap are attached. A switch 500 is inserted in cap 400.

It is to be agreed that a term such as “top” is conventionally used in the present description with reference to a position when multiple screwdriver 100 is perpendicularly directed on a horizontal surface.

Tubular body 200 has, in cross section, a generally trapezoidal periphery with rounded corners. Towards tip 300, tubular body 200 extends axially and changes in a truncated cone 202, followed by a first cylindrical end 204. One of the external faces of tubular body 200 has, on a part of its length, a flattened surface 206. First cylindrical end 204 has a reduced cross section in comparison with the smallest cross section of truncated cone 202. Thus, a first shoulder 208 is formed. A notch 210, outwardly open, is provided in first cylindrical end 204, at the external end of the latter.

Tubular body 200, at the end where cap 400 is disposed, extends into a second cylindrical end 212, having a reduced cross section in comparison with the main cross section of tubular body 200. Thus, a second shoulder 214 is formed between the trapezoidal cross section with rounded corners of tubular body 200 and second cylindrical end 212. The latter is provided on its periphery with two spaced longitudinally extending ribs 215.

Tubular body 200 which incorporated as well truncated cone 202 and first and second cylindrical ends 204 and 212, respectively, is axially contoured to be operatively associated with several interchangeable screwdriver tips. To this end, an axially extending bore 218, hexagonal in cross section passes along tubular body 200. Thus, a storage compartment for releasably retaining interchangeable screwdriver tips 216 in axially spaced relation to tubular body 200 is formed. The hexagonal cross section of shank 220 is so commensurate with axially extending bore 218 to allow an easy passage of screwdriver tips 216. Each interchangeable screwdriver tip 216 includes a shank 220, also hexagonal in cross section, which extends into a bit 222. Obviously, different forms of bits 222 are used.

Tip 300 has truncated hollow cone form, which extends as a continuation of truncated cone 202. A cylindrical opening 302 passes through tip 300 except at the outer end where an inwardly extending centering rim 304 is formed. The latter has a hexagonal aperture, which dimensionally and positionally coincides with hexagonal cross section of axially extending bore 218. In order to obtain the abovementioned alignment, a tooth 306, projecting from inwardly extending centering rim 304, is provided. Tooth 306 is intended to penetrate notch 210 when tip 300 is assembled with tubular body 200. The length of cylindrical opening 302 is slightly greater than the length of first cylindrical end 204, so that a gap is formed when the former and the latter are assembled.

A C-shaped springy element 308 is placed in the gap. The internal circumference of C-shaped springy element 308 is so sized to circumscribe the hexagonal aperture in inwardly extending centering rim 304. The purpose of C-shaped springy element 308 is to engage frictionally a shank 220, which is in tip 300, while its bit 222 projects outwardly from tip 300. Thus, an interchangeable screwdriver tip, that is located in tip 300, is prevented from falling out and, so, the successive interchangeable screwdriver tips 216, disposed behind it, are confined in the storage compartment of tubular body 200.

Cap 400 has a lateral wall 402, which, generally, has in cross section the same trapezoidal periphery with rounded corners as tubular body 200. An interior 404 of cap 400 is basically cylindrical. Cap 400 is formed to have at the top a disk shaped opening 406, which is formed by an inwardly extending rounded rim and has a cross section larger than the hexagonal cross section of shank 220.

At the top, lateral wall 402 overhangs radially and outwardly and forms a protrusion 408, the purpose of which will be explained further in the disclosure.

Immediately, beneath protrusion 408 an open window 410 is formed in lateral wall 402. Open window 410 has a wide part 412 at the top, which continues downwardly with a narrow part 414. Wide part 412 has a lateral side collinear with a lateral side of narrow part 414. Beneath window 410, lateral wall 402 extends first outwardly and then downwardly forming a clip 416. The latter is intended to be disposed, when multiple screwdriver 100 is assembled, above flattened surface 206 of tubular body 300.

In interior 404 of cap 400, a longitudinal slit 418 extends radially in lateral wall 402. Longitudinal slit 418 starts at the bottom of cap 400 and terminates in window 410, respectively in narrow part 414.

A pair of axial spaced slots 420, located in interior 404, opposite longitudinal slit 418, starts also at the bottom of cap 400 and extends radially in lateral wall 402. Inwardly, the pair of space axial slots 420 reaches an intermediate point between the top and bottom of cap 400. Switch 500 has the shape of a hollow right circular cylinder and is coaxially aligned and diametrically commensurate with second cylindrical end 212. A tooth projection 502 is formed on the external surface of switch 500, approximately at the middle of its length. The interior of switch 400 is generally cylindrical, except at the top where a hexagonal configuration 504 is formed. The latter corresponds to the cross section of shank 220, while the diameter of the cylindrical interior is such that allows free passage of any interchangeable screwdriver tip 216. After all interchangeable screwdriver tips 216 are successively inserted into axially extending bore 218 of tubular body 200 and first interchangeable screwdriver tip 216 had its bit 222 projecting outwardly from tip 300, the last interchangeable screwdriver tip 216 is so situated, that its top is beneath hexagonal configuration 504. By turning tooth projection 502 to the left or right in wide part 412 of window 410, hexagonal configuration 502 can be position to coincide with the hexagonal position of shank 220, or be displaced from this position. When it coincides, interchangeable screwdriver tips 216 can be introduced into tubular body 200, or let fall out when multiple screwdriver 100 is positioned approximately upside down. When switch 500 is displaced from the coincidental position, the passage of interchangeable screwdriver tips 216 is prevented.

Small protrusion 408 which projects from cap 400 is intended to overhang above tooth projection 502, so the latter cannot be touched and switched accidentally by the users hand during the operation of multiple screwdriver.

For releasably retaining tip 300 and cap 400 on tubular body 200, this external surfaces of first and second cylindrical ends 204 and 212, respectively, and the surfaces of cylindrical opening 302 in tip 300 and of interior 404 in cap 400 are knurled or provide with ridges or ribs for snapping.

Alternatively, tip 300, cap 400 and tubular body 200 can be permanently attached by gluing, welding or other means. Since various methods of attachment are well known to those skilled in the art, further detailed discussion of this aspect of attachment is not deemed necessary.

As required, a detailed embodiment of the present invention is disclosed herein; however, it is to be understood that the disclosed embodiment is merely exemplary of the invention, which may be embodied in various forms. Therefore, specific structures and functional details disclosed herein are not to be interpreted as limiting, but merely as a basis for teaching one skilled in the art to variously employ the present invention in virtually any appropriately detailed structure.

The embodiments of the invention in which an exclusive property or privilege is claimed are defined as follows:

1. A multiple screwdriver comprising, in combination,
tubular body means having two ends;
tip means attached to one of said ends;
cap means attached to the other one of said ends;
said tubular body means incorporating
first cylindrical end means generally located to correspond positionally to said tip means;
second cylindrical end means generally disposed to correspond positionally to said cap means;
an axially extending bore of hexagonal cross section along the length of the tubular body, providing a storage compartment adaptable for releasably retaining several interchangeable screwdriver tips, each of the latter having a shank with a hexagonal Cross-section commensurable with said axially extending bore;
said tip means having a cylindrical opening ending at an outer end with an inwardly extending centering rim provided with a hexagonal aperture for an easy passage of said interchangeable screwdriver tips;
a C-shaped springy means located in said tip means between said inwardly extending centering ream and said first cylindrical end, said C-shaped springy means been so dimensioned that its internal circumference circumscribe set hexagonal aperture in said inwardly extending rim, said C-shaped spring means frictionally engaging said shank, whose bit is projecting outwardly from said tip means;
said cap means having at its top a disk shape opening for an easy passage of said interchangeable screwdriver tips, an open window being formed in a lateral wall of said cap means, set open window having a wide part at the top which continues downwardly with a narrow part; and
switch means of tubular form coaxially aligned and diametrically commensurate with said second cylindrical end, said switch being provided on its external surface by a tooth projection, an interior of said switch means being generally cylindrical, except at the top where a hexagonal configuration is formed, the latter corresponding to said cross section of said shank, the rest of said interior being so sized to allow an easy passage of said interchangeable screwdriver tips;
whereby by pivoting said tooth projection in one direction or in an opposite direction, said hexagonal configuration in said top of said switch means can take a position coinciding dimensionally and positionally with that axially extending bore, or can take an opposite position, when said hexagonal configuration in said top of said switch and in said axially extending bore, respectively its hexagonal cross section, do not coincide.

2. Multiple screwdriver, as defined in claim 1, wherein set tubular body means having in cross section a generally trapezoidal periphery with rounded corners, toward said tip means said tubular body extending axially and changing in a truncated cone, followed by said first cylindrical end, one of the external faces of the tubular body means having on one a part of its length a flattened surface, said first cylindrical end having a reduced cross section in comparison with the smallest cross section of said truncated cone, thus, a first shoulder is formed, and a notch outwardly open is formed in said first cylindrical end, at an external end of the latter, said tubular body means, at the end where said cap means is disposed, extends into said second cylindrical end, the latter having on its periphery two spaced longitudinal ribs.
